(19) United States
(12) Patent Application Publication
(10) Pub. No.: US 2026/0082161 A1
(43) Pub. Date: Mar. 19, 2026

(54) Systems and Methods for Implementing a Machine Learning Model to Optimize Sound Processing Program Parameters

(71) Applicant: SONOVA AG, Staefa (CH)

(72) Inventors: Gilles Courtois, Uerikon (CH); Stefan Raufer, Stäfa (CH)

(21) Appl. No.: 18/887,778

(22) Filed: Sep. 17, 2024

(51) Int. Cl. H04R 25/00

(52) U.S. Cl. CPC H04R 25/505; H04R 25/407; H04R 2225/41; H04R 2460/01

(57) ABSTRACT

An exemplary hearing device includes a memory that stores instructions and a processor communicatively coupled to the memory and configured to execute the instructions to perform a process. The process may comprise processing an audio signal in accordance with a sound processing program along a first signal processing path, the sound processing program configured to compensate for individual hearing loss of a user of the hearing device; identifying information associated with the audio signal; providing the information associated with the audio signal to a trained machine learning model that processes the information along a second signal processing path, the trained machine learning model configured to output one or more parameters that are optimized on the fly for the sound processing program based on the information; and applying the one or more parameters output from the trained machine learning model to the sound processing program.

### BACKGROUND INFORMATION

Hearing devices (e.g., hearing aids, ear buds, etc.) may enable or enhance hearing by providing audio content received by the hearing device to a user. In certain examples, hearing devices may be configured to process a received input sound signal (e.g., ambient sound) and provide the processed input sound signal to the user (e.g., by way of a receiver (e.g., a speaker) placed in the user’s ear canal or at any other suitable location).

Conventional hearing devices are configured to process a received input sound signal according to any number of sound processing programs to facilitate a user perceiving sound. For example, a hearing device may be configured to implement a target gain program, a beamformer program, a noise canceling program, and/or any other suitable sound processing program. Typically, conventional hearing devices implement a one-size-fits-all approach for parameterization of such sound processing programs. For example, beamformer weights that may be used in a monaural or binaural beamformer are typically fixed and are independent of the position of the hearing device(s) on the ear, the head anatomy, user behavior, and/or the scene. As another example, calculations of a desired target gain are often based on a gain model taking into account compensation of an individual hearing loss in a fixed manner. Further, noise canceling programs are typically assigned to fixed programs instead of using the best solution for a given scene. As such, the parameters used for such sound processing programs may not be optimal for each situation in which a hearing device may be used, resulting in degraded hearing device performance. Accordingly, there remains room to improve the parametrization of hearing device programs implemented by hearing devices.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary audio content processing system that may be implemented according to principles described herein.

FIG. 2 illustrates an exemplary implementation of a hearing device according to principles described herein.

FIG. 3 illustrates an exemplary flow diagram that may be implemented according to principles described herein.

FIGS. 4, 5A, and 5B illustrate exemplary signal processing paths that may be implemented according to principles described herein.

FIG. 6 illustrates an exemplary diagram depicting training of a machine learning model according to principles described herein.

FIGS. 7-9 illustrate additional exemplary signal processing paths that may be implemented according to principles described herein.

FIG. 10 illustrates an exemplary method for implementing a machine learning model to optimize sound processing program parameters according to principles described herein.

FIG. 11 illustrates an exemplary computing device according to principles described herein.

### DETAILED DESCRIPTION

Systems and methods for implementing a machine learning model to optimize sound processing program parameters are described herein. As will be described in more detail below, an exemplary hearing device includes a memory that stores instructions and a processor communicatively coupled to the memory and configured to execute the instructions to perform a process. The process may comprise processing an audio signal in accordance with a sound processing program along a first signal processing path, the sound processing program configured to compensate for individual hearing loss of a user of the hearing device; identifying information associated with the audio signal; providing the information associated with the audio signal to a trained machine learning model that processes the information along a second signal processing path, the trained machine learning model configured to output one or more parameters that are optimized on the fly for the sound processing program based on the information; and applying the one or more parameters output from the trained machine learning model to the sound processing program.

Hearing devices such as those described herein may be used to detect sound and process or modify that sound for output to a user. Sound or audio processing may be performed in different ways, using different hardware and/or software in order to achieve particular goals for the user of a hearing aid. In this regard, frequency domain block-based or time domain sample-based audio processing may provide capabilities of various desired hearing aid functionalities (e.g., gain, beamformer, noise reduction, feedback cancellation). Time domain processing may provide lower latency than a frequency domain-based implementation. This may be achieved, for example, by using a cascaded and/or parallel structure of time domain filters that may include infinite impulse response (“IIR”) filters, finite impulse response (“FIR”) filters, or a combination of both. In low-latency applications, IIR filters may be preferred as compared to FIR filters, as the IIR filters are more efficient (e.g., require less operation), generate less latency, and/or may offer some prediction capabilities which turns into negative group delay. However, contrary to FIR filters, IIR filters may be unstable, thereby providing a diverging output signal.

As such, described herein are advantageous apparatuses, systems, and methods for using adaptive filters (e.g., adaptive IIR filters) in the time domain to provide for low-latency audio processing, while also providing stability so that an output signal does not become unstable. Such implementations may provide for audio processing with IIR filters purely in the time domain.

The various implementations described herein may utilize artificial intelligence (“AI”), deep neural networks (“DNNs”), machine learning models, etc. to train a model or algorithm to determine, in real time or otherwise with very low latency, coefficients for IIR filters in a hearing device or system or other parameters for a hearing device or system. The various audio processing models or algorithms described herein may be previously trained to calculate filter coefficients for IIR filters to achieve a desired magnitude response (e.g., according to a target gain curve for a given user of a hearing device or system). As such, in hearing aid applications, the audio processing models described herein may advantageously consider or utilize magnitude and phase for gain model processing using a trained audio processing model such as a machine learning or AI algorithm. For example, systems and methods such as those described herein may implement a trained machine learning model to dynamically determine which parameter(s) to use based on a current scene and/or context in which a hearing device is being used. Other benefits of the systems and methods described herein will be made apparent herein.

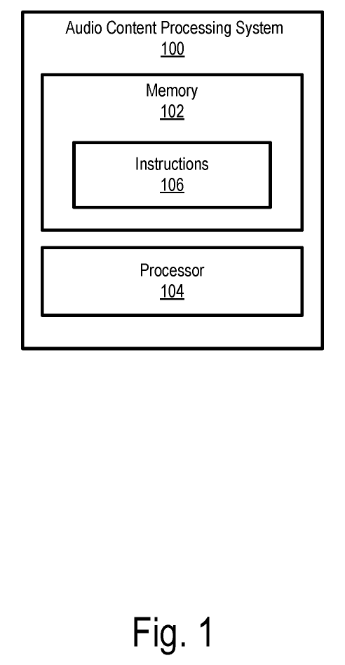

FIG. 1 illustrates an exemplary audio content processing system 100 (“system 100”) that may be implemented according to principles described herein. As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device such as described herein. In other examples, memory 102 and/or processor 104 may be distributed between multiple devices and/or multiple locations as may serve a particular implementation. Illustrative implementations of system 100 are described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store hearing loss profile data, user preference data, setting data, data associated with a plurality of sound processing programs, sound processing program parameters (e.g., filter coefficients, beamformer weights, etc.), input sound classification data, target gain curve data, machine learning data, graphical user interface content, notification data, and/or any other suitable data.

Processor 104 may be configured to perform (e.g., execute instructions 106 stored in memory 102 to perform) various processing operations associated with implementing a machine learning model to optimize sound processing program parameters. For example, processor 104 may perform one or more operations described herein to apply, to a sound processing program, one or more parameters that are output by a trained machine learning model and that are optimized on the fly for the sound processing program. These and other operations that may be performed by processor 104 are described herein.

As used herein, a “hearing device” may be implemented by any device or combination of devices configured to output sound to a user to compensate for individual hearing loss of the user. For example, a hearing device may be implemented by a hearing aid configured to amplify audio content to a recipient, a sound processor included in a cochlear implant system configured to apply electrical stimulation representative of audio content to a recipient, a sound processor included in a stimulation system configured to apply electrical and acoustic stimulation to a recipient, or any other suitable hearing prosthesis. In some examples, a hearing device may be implemented by a behind-the-ear (“BTE”) housing configured to be worn behind an ear of a user. As used herein, a “BTE housing or component” may refer to any type of hearing device that may be provided at least partially behind an ear when worn by a user. In some examples, a hearing device may be implemented by an ITE component configured to at least partially be inserted within an ear canal of a user. As used herein, an “ITE component” may refer to any type of hearing device that may be partially inserted within an ear canal of a user when worn by a user. In some examples, a hearing device may include a combination of an ITE component, a BTE housing, and/or any other suitable component. For example, in certain examples, a hearing device may be implemented by a receiver-in-canal (“RIC”) device. In such examples, certain electronics (e.g., microphones, a battery, etc.) may be located in a BTE housing, but a receiver is positioned within the ear canal and is connected to the BTE housing by way of a wire. In certain alternative examples, a receiver may be positioned within a BTE housing and sound may be transferred into the ear canal via a sound tube that connects the BTE housing to an ITE component that is provided at least partially within the ear canal of the user.

In certain examples, hearing devices such as those described herein may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type. For example, a first hearing device may be a hearing aid and a second hearing device may be a sound processor included in a cochlear implant system.

System 100 may be implemented in any suitable manner. For example, system 100 may be implemented by a hearing device, a communication device (e.g., a smartphone) communicatively coupled to the hearing device, or a combination of the hearing device and any suitable computing device or combination of computing devices that may be configured to implement one or more sound processing programs configured to compensate for individual hearing loss of a user of a hearing device.

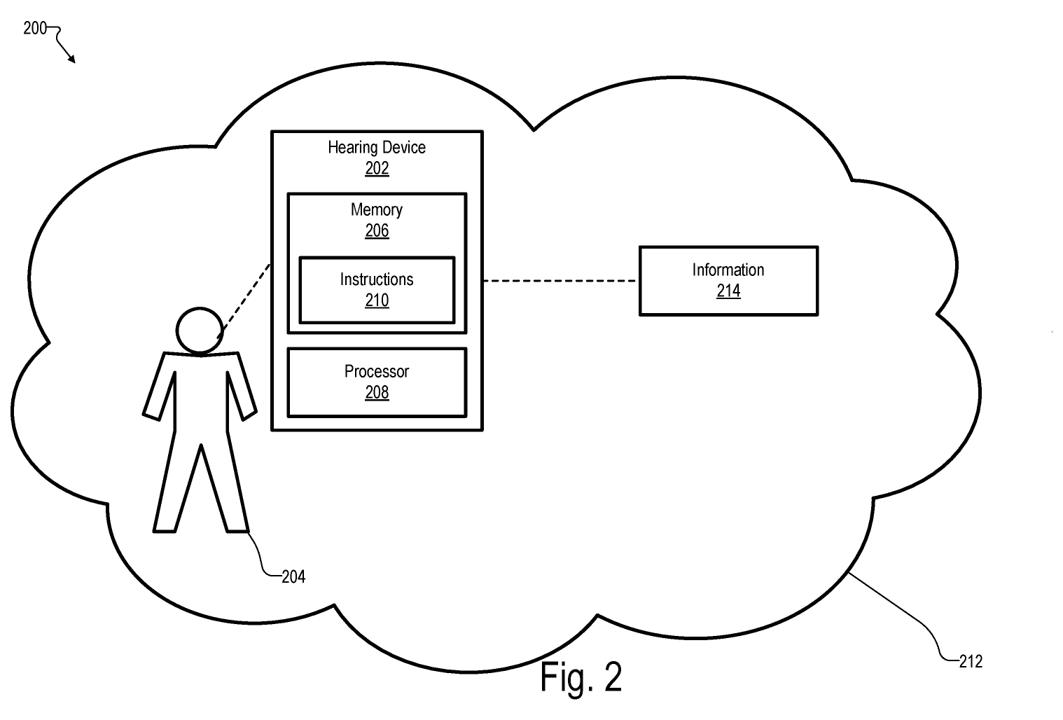

FIG. 2 shows an exemplary implementation 200 of a hearing device that may implement system 100 according to principles described herein. As shown in FIG. 2, implementation 200 includes a hearing device 202 that is associated with a user 204. User 204 may correspond to any individual that is a user of a hearing device such as described herein.

Hearing device 202 may correspond to any suitable type of hearing device such as described herein. Hearing device 202 may include, without limitation, a memory 206 and a processor 208 selectively and communicatively coupled to one another.

Memory 206 and processor 208 may each include or be implemented by hardware and/or software components (e.g., processors, memories, communication interfaces, instructions stored in memory for execution by the processors, etc.). In some examples, memory 206 and processor 208 may be housed within or form part of a BTE housing. In some examples, memory 206 and processor 208 may be located separately from a BTE housing (e.g., in an ITE component). In some alternative examples, memory 206 and processor 208 may be distributed between multiple devices (e.g., multiple hearing devices in a binaural hearing system) and/or multiple locations as may serve a particular implementation.

Memory 206 may maintain (e.g., store) executable data used by processor 208 to perform any of the operations associated with hearing device 202. For example, memory 206 may store instructions 210 that may be executed by processor 208 to perform any of the operations associated with hearing device 202 assisting a user in hearing. Instructions 210 may be implemented by any suitable application, software, code, and/or other executable data instance.

Memory 206 may also maintain any data received, generated, managed, used, and/or transmitted by processor 208. For example, memory 206 may maintain any suitable data associated with a hearing loss profile of a user, etc. Memory 206 may maintain additional or alternative data in other implementations.

Processor 208 is configured to perform any suitable processing operation that may be associated with hearing device 202. For example, when hearing device 202 is implemented by a hearing aid device, such processing operations may include monitoring ambient sound and/or representing sound to user 204 via an in-ear receiver. Processor 208 may be implemented by any suitable combination of hardware and software. In certain examples, processor 208 may correspond to or otherwise include one or more dedicated DNN chips configured to perform any suitable machine learning operation such as described herein.

As shown in FIG. 2, hearing device 202 may be located in an ambient environment 212 associated with user 204. Ambient environment 212 may correspond to any environment where hearing device 202 may be used by user 204. For example, ambient environment 212 may correspond to a home environment, a work environment, a public transit environment, a restaurant environment, an outdoor environment, and/or any other suitable environment. While user 204 and hearing device 202 are in ambient environment 212, hearing device 202 may implement one or more sound processing programs to facilitate user 204 perceiving an audio signal represented in ambient environment 212.

Conventionally, such sound processing programs may be generally configured to operate in any number of environments but may not be optimized for a particular environment. For example, a conventional beamformer algorithm implemented by a hearing device may be configured to use the same beamformer weights regardless of how the hearing device is worn by a user and/or regardless of what type of environment the user is in. In contrast, system 100 may be configured to improve the performance of sound processing programs by leveraging a trained machine learning model to optimize one or more parameters used by the sound processing program(s). To that end, system 100 may be configured to access or otherwise obtain information 214 associated with hearing device 202, user 204, and/or ambient environment 212. Information 214 may include any suitable information that may be associated with hearing device 202, user 204, and/or ambient environment 212. For example, information 214 may include an environment type, sensor information (e.g., motion sensor data), target gain curve data, sound attributes of an ambient environment, input sound classification data, and/or any other suitable information. As will be described further herein, information 214 may be used in any suitable manner to facilitate optimizing which parameters to use for sound processing programs.

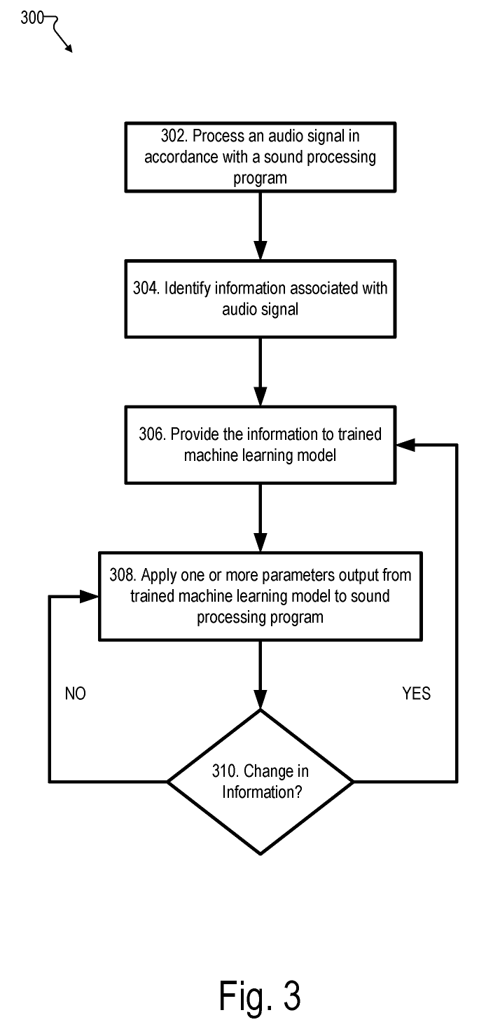

To illustrate, FIG. 3 shows an exemplary flow diagram 300 with various operations that may be performed by system 100 (e.g., processor 208 of hearing device 202) in implementing a machine learning model to process an audio signal. As shown in FIG. 3, at operation 302, system 100 may process an audio signal in accordance with a sound processing program. The sound processing program may correspond to any suitable type or combination of sound processing programs that may be implemented by system 100 and may be configured to compensate for individual hearing loss of a user of a hearing device such as hearing device 202. In certain examples, the sound processing programs may include one or more amplification programs for an audio signal. Additionally or alternatively, the sound processing programs may include one or more signal conditioning programs configured to improve signal to noise attributes of an audio signal. For example, the sound processing programs may include a gain model algorithm that implements one or more adaptive filters, a beamformer algorithm, a feedback canceler algorithm, a noise canceling program that is configured to implement a plurality of different noise canceling programs, and/or any other suitable sound processing program. In some examples, the adaptive filters may include an IIR filter.

System 100 may process the audio signal in any suitable manner. For example, system 100 may process the audio signal in accordance with a sound processing program in a time domain along a first signal processing path. Additionally or alternatively, system 100 may process the audio signal in accordance with a sound processing program in a frequency domain along the first signal processing path.

At operation 304, system 100 may identify information associated with the audio signal. This may be accomplished in any suitable manner. For example, system 100 may derive the information associated with the audio signal from the audio signal itself (e.g., based on information in the audio signal). Additionally or alternatively, the information associated with the audio signal may not be derived from the audio signal. For example, the information associated with the audio signal may be derived by system 100 based on detected environmental conditions, GPS information indicating a location of the user, physiological information, and/or any other suitable condition, attribute, etc. that may be associated with the user, the hearing device, and/or the environment in which the hearing device is used. In certain examples, in identifying the information, system 100 may determine an input sound classification associated with sound in an environment in which a hearing device is located. The input sound classification may correspond to any suitable classification that may be associated with sound in an environment associated with a hearing device. In certain examples, there may be a plurality of different input sound classifications that may be associated with sound in an environment. For example, there may be a first input sound classification, a second input sound classification, a third input sound classification, and so forth.

Each input sound classification may be associated with a different sound situation that may be experienced by user 204. For example, a first input sound classification may correspond to a speech classification, a second input sound classification may correspond to a music classification, a third input sound classification may correspond to a noisy environment classification, and so forth.

System 100 may determine the input sound classification in any suitable manner. For example, system 100 may use a microphone of hearing device 202 to detect sound in the environment surrounding user 204. Based on the detected sound, system 100 may determine whether the input sound classification corresponds, for example, to a speech classification, a noisy environment classification, or any other suitable type of input sound classification such as those described herein.

In certain examples, system 100 may access information from one or more sensors of hearing device 202 to facilitate identifying the information associated with an audio signal. For example, system 100 may access data from one or more motion sensors (e.g., accelerometers, gyroscopes, and/or inertial measurement units (“IMU”s)), location sensors, physiological sensors such as heart rate sensors, temperature sensors, and/or bioelectric sensors (e.g., electroencephalography (“EEG”) sensors, electrooculography (“EOG”) sensors, and/or electrocardiography (“ECG”) sensors). To illustrate an example, system 100 may access global position system (“GPS”) data from a GPS sensor of hearing device 202 to determine where hearing device 202 is currently located. Based on the GPS data, system 100 may determine whether hearing device 202 is located in any one of a plurality of different types of scenes. For example, the location may indicate that hearing device 202 is currently at a restaurant. Accordingly, system 100 may determine that the information indicates that hearing device 202 is located at a noisy restaurant type of scene or environment.

At operation 306, system 100 may provide the audio signal and the information to a trained machine learning model. The trained machine learning model may implement any suitable type of machine learning methodology as may serve a particular implementation. For example, in certain implementations, the trained machine learning model may implement a DNN, a convolutional network (“CNN”), a Kalman filter, a Markov model, and/or a Bayesian network to process. The trained machine learning model may process the audio signal along a second signal processing path that is different from the first signal processing path.

In certain examples, the second signal processing path may be different than the first signal processing path. For example, the first signal processing path may have a first latency and the second signal processing path may have a second latency that is different than the first latency. In certain examples, the first latency may be less than the second latency. A low-latency path or low-delay path generally means a path with low delay. The low-latency path has low-delay because a basic or simple digital signal operation is applied in that path such as time-domain beamformer, transducer compensations, frequency-dependent gains, and/or automatic gain control. A long-latency path or long-delay path generally means a path with high delay (higher than the low latency path). The long-latency path is associated with more advanced signal processing operations such as neural network computations that may be performed in accordance with a trained machine learning model such as described herein. In the systems and methods described herein, the first signal processing path may be generally associated with the low-latency path and the second signal processing path may be associated with long-latency path.

In certain examples, the second signal processing path may be considered as a long-latency path due to the specific type of processing performed along the second signal processing path. For example, system 100 may implement block processing along the second signal processing path in certain implementations. The block processing may result in latency of the second signal processing path being relatively larger than the latency of the first signal processing path due to the delay of collecting a block of signal samples and the subsequent block processing. In such examples, the information associated with the audio signal may be identified by block processing of the audio signal (e.g., by filling a block of temporarily successive signal samples before beginning the computation to accumulate enough information content from the audio signal). In certain examples, the block processing of the audio signal may include using a fast Fourier transform (“FFT”) to analyze a frequency spectrum of the audio signal.

In certain examples, the processing performed in the first signal processing path may be performed in the time domain. In certain alternative examples, the processing performed in the first signal processing path may be performed in the frequency domain.

The trained machine learning model may be configured to output one or more parameters that are optimized on the fly for the sound processing program based on the information. Optimizing one or parameters on the fly may be performed in any suitable manner. For example, such optimizing of one or more parameters may include updating the parameters of a sound processing program during operation of the sound processing program. The updating of the one or more parameters may be performed continually, periodically, or at any suitable interval during operation of the sound processing program. In certain examples, the one or more parameters may be updated in real time or near real time while running the sound processing program and/or without interrupting operation of the sound processing program.

Any suitable parameters may be optimized on the fly as may serve a particular implementation. For example, in implementations where the sound processing program corresponds to a gain model algorithm that implements an adaptive filter, the one or more parameters optimized by the machine learning model may include at least one of a filter bank structure, a filter order, or filter coefficients for the adaptive filter. In implementations where the sound processing program corresponds to a beamformer algorithm, the one or more parameters optimized by the machine learning model may include beamformer weights used by the beamformer algorithm. In implementations where the sound processing program corresponds to a noise canceling algorithm, the one or parameters optimized by the machine learning model may include a noise canceling program selected from a plurality of different noise canceling programs.

At operation 308, system 100 may apply the one or more parameters output from the trained machine learning model to the sound processing program. This may be accomplished in any suitable manner. For example, system 100 may replace the one or more parameters currently set for the sound processing program to the one or more parameters that are optimized by way of the trained machine learning model.

At operation 310, system 100 may determine whether there has been a change in the information associated with hearing device 202. If the answer at operation 310 is “NO,” the flow may return to operation 308 and system 100 may continue to use the one or more parameters previously output from the trained machine learning model. If the answer at operation 310 is “YES,” the flow may proceed to operation 306 and system 100 may provide additional information and the audio signal to the trained machine learning model. The trained machine learning model may then output one or more additional parameters that are optimized on the fly for the sound processing program based on the additional information.

System 100 may be configured to repeat operations 306-310 any suitable number of times to dynamically adjust the parameters applied to a sound processing program as the information associated with an audio signal changes during use of hearing device 202.

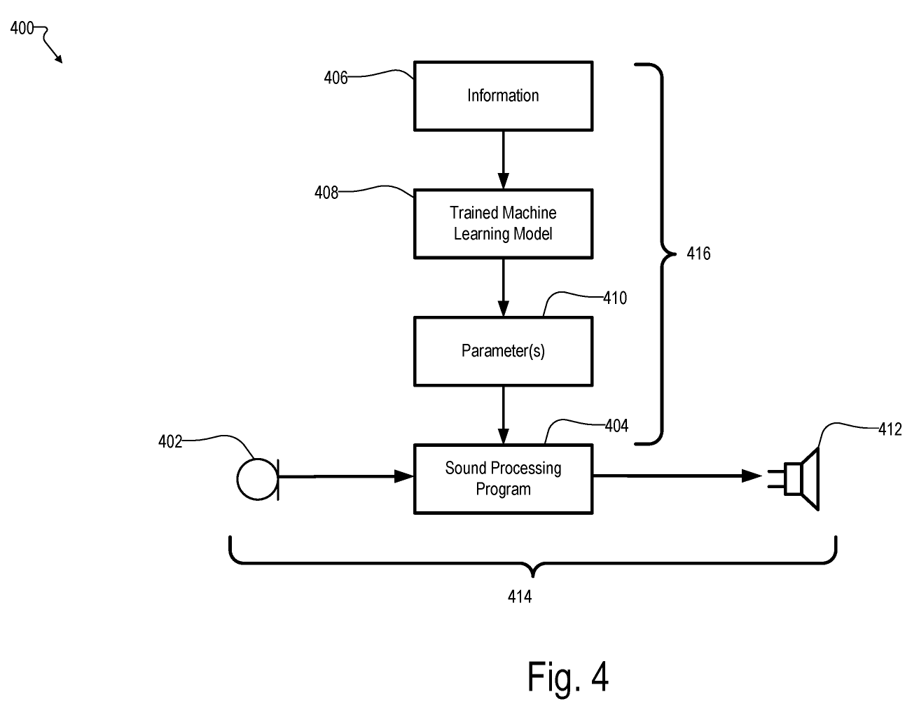

FIG. 4 shows an exemplary implementation 400 that depicts different signal processing paths that may be implemented according to principles described herein. As shown in FIG. 4, a microphone 402 is configured to pick up an audio signal that is then transmitted to a sound processing program 404. In certain examples, the audio signal may be transformed into the time domain by an analog to digital converter. Sound processing program 404 may correspond to any type of sound processing program such as those described herein. In addition, information 406 associated with the audio signal is provided as input to a trained machine learning model 408. Trained machine learning model 408 is configured to output one or more parameters 410 that are optimized on the fly for sound processing program 404 based on information 406. Parameters 410 output by trained machine learning model 408 are then applied to sound processing program 404 in any suitable manner. For example, parameters 410 are applied to sound processing program 404 in place of previous parameters of sound processing program 404. The audio signal output by sound processing program 404 is then output to be presented to a user by way of a receiver (e.g., a speaker) 412. In certain examples, the audio signal output by sound processing program 404 may be transformed back to the frequency domain by a digital to analog converter to be presented to the user by way of receiver 412.

As shown in FIG. 4, the audio signal is processed along a first signal processing path 414 by sound processing program 404. In addition, the audio signal is processed along a second signal processing path 416 by trained machine learning model 408. First signal processing path 414 may have a relatively lower latency than second signal processing path 416. For example, the latency of first signal processing path 414 may be less than or equal to ten milliseconds. In contrast, the latency of second signal processing path 416 may be greater than or equal to one second. In certain examples, sound processing program 404 implemented along first signal processing path 414 may solely be implemented by adaptive filters (e.g., IIR filters).

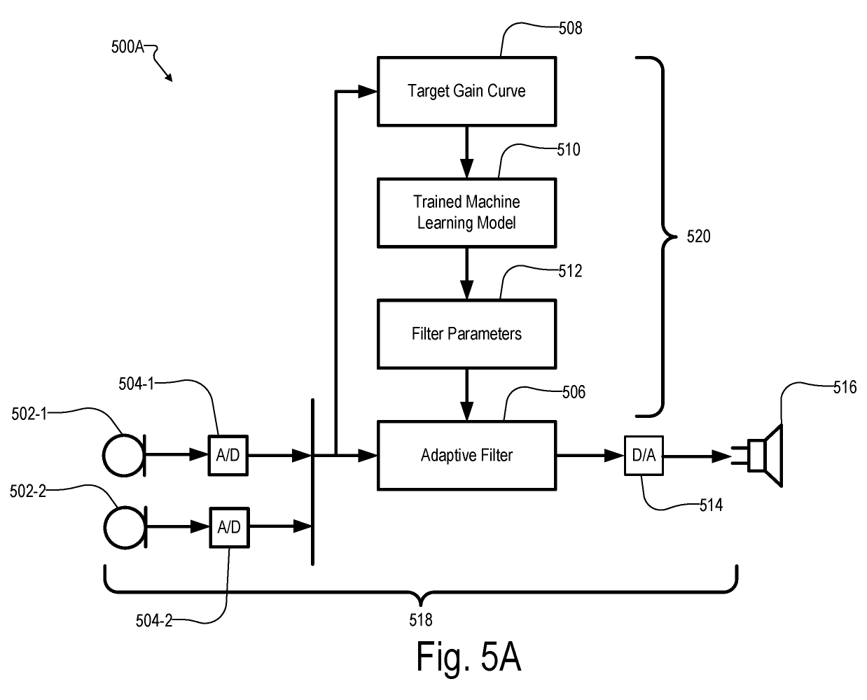

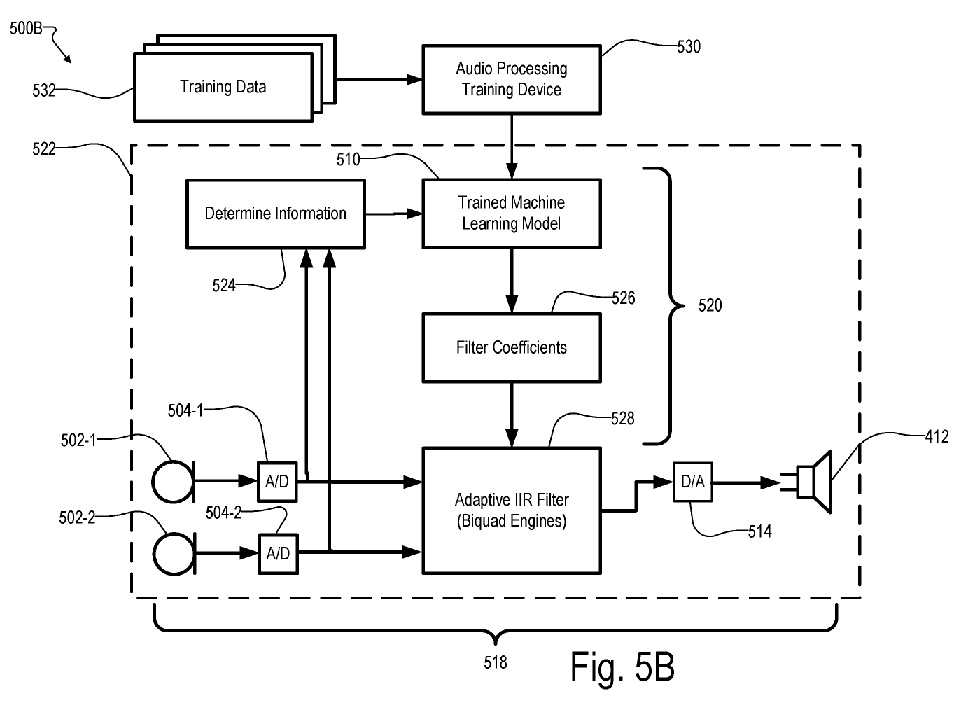

To illustrate, FIG. 5A shows an exemplary implementation 500A that depicts different signal processing paths that may be implemented according to principles described herein when system 100 implements a gain model algorithm that uses an adaptive filter as a sound processing program. As shown in FIG. 5A, and audio signal may be picked up by a plurality of microphones 502 (e.g., microphones 502-1 and 502-2). The audio signal is then transformed into the time domain by analog to digital converters 504 (e.g., analog to digital converters 504-1 and 504-2). The audio signal is provided to an adaptive filter 506 (e.g., an IIR filter). Adaptive filter 506 may be considered as “adaptive” because adaptive filter 506 may be designed and/or optimized in real time or near real time (e.g., during operation of adaptive filter 506 and/or without interrupting operation of adaptive filter 506). In certain examples, adaptive filter 506 may be implemented by a biquad engine. In such examples, adaptive filter 506 may use a plurality of chained and/or parallel IIR filters to process the transformed audio signals. The audio signal and a target gain curve 508 are provided as inputs to trained machine learning model 510, which is configured to output filter parameters 512 on the fly for adaptive filter 506. Target gain curve 508 is a function of the input audio signal. As such, system 100 may be configured to calculate the target gain curve 508 in real time based on the audio signal.

Trained machine learning model 510 may determine which parameters to use in any suitable manner. For example, trained machine learning model 510 may be trained to determine which filter coefficients to implement by using a gain curve to coefficients mapping function. The parameters determined by trained machine learning model 510 may be selected to ensure the best low-latency approximation of the target gain curve.

Filter parameters 512 may correspond to any suitable parameters that may be optimized for adaptive filter 506. For example, filter parameters 512 may include a filter bank structure, a filter order, and/or filter coefficients for adaptive filter 506. Filter parameters 512 are then applied in any suitable manner to adaptive filter 506. As shown in FIG. 5A, the audio signal output from adaptive filter 506 is transformed back to the frequency domain by a digital to analog converter 514 to be presented to a user by a receiver 516.

In the example shown in FIG. 5A, adaptive filter 506 processes the audio signal along a first signal processing path 518 and trained machine learning model 510 processes the audio signal along a second signal processing path 520. Similar to the example shown in FIG. 4, first signal processing path 518 may have a first latency and second signal processing path 520 may have a second latency that is different than the first latency.

In the example shown in FIG. 5A, first signal processing path 518 may process the audio signal in the time domain. However, it is understood that alternative implementations may include the audio signal being processed along first signal processing path 518 in the frequency domain (e.g., by a FFT which increases latency).

FIG. 5B shows another an exemplary implementation 500B that depicts different signal processing paths that may be implemented according to principles described herein. As shown in FIG. 5B, microphones 502-1 and 502-2 of a hearing device 522 are configured to pick up an audio signal that is then transformed into the time domain by analog to digital converters 504-1 and 504-2. After transformation, first and second input audio signals (e.g., in a combined or separate form) are input in an information determination block 524 to determine information associated with the audio signal. For example, information determination block 524 may perform a block-based processing of the input audio signals. In some examples, the determining of the information at block 524 may include calculating, based on the processed audio signal, a target gain. In some examples, the determining of the information at block 524 may additionally include determining an acoustic scene. The determined information (and/or additional information (e.g., scene classification information) is input into the trained machine learning model 510 so that the trained machine learning model 510 included in hearing device 522 generates, based on the determined information, optimized filter coefficients 526 for adaptive IIR filter 528. It is understood that trained machine learning model 510 may be specifically trained to output optimized filter coefficients 526 for adaptive IIR filter 528.

In addition to the information, additional data may be provided to trained machine learning model 510 from an audio processing training device 530, which may correspond to any suitable controller. For example, audio processing training device 530 may correspond to a fitting system or fitting software that may be used to adapt a target gain calculation to an individual hearing loss of a user. In the example shown in FIG. 5B, audio processing training device 530 may receive training data 532 which may be used train a machine learning model in any suitable manner. Training data 532 may comprise any suitable type or combination of information as may serve a particular implementation. For example, training data 532 may comprise one or more of one-dimensional input data (e.g., gain curves labeled with filter coefficients), data pairs (e.g., labeled with filter coefficients), data triplets (e.g., labeled with filter coefficients), etc. In certain examples, training data 532 may be used to adapt the target gain calculation to the individual hearing loss. In certain examples, training data 532 may correspond to audio information associated with filter coefficients.

The audio signal is then transformed back to the frequency domain by a digital to analog converter 514 and then presented to a user by way of receiver 412.

As shown in FIG. 5B, the audio signal is processed along a first signal processing path 518 by hearing device 522. In addition, the audio signal is processed along a second signal processing path 520 by hearing device 522. Second signal processing path 520 may have a relatively higher latency than the latency of first signal processing path 518 due, for example, to block processing that may be performed along second signal processing path 520.

Machine learning models such as those described herein may be trained in any suitable manner using any suitable combination of training operations. For example, in training a machine learning model, a loss function may be used that measures how well the machine learning model performs on training data. The loss function may quantify the difference between predicted outputs and actual target values. Parameters of the machine learning model may be initialized with some initial values. In certain examples, the parameters used to initialize the machine learning model may correspond to weights in a neural network, coefficients in a regression model, and/or any other adjustable values that the machine learning model may learn. Any suitable optimization algorithm may be used to minimize the loss function. In certain examples, a Gradient Descent optimization algorithm may be used.

Machine learning models such as those described herein may implement single-channel inputs in certain examples. However, it is understood that machine learning models such as those described herein are not restricted to single-channel inputs. For example, machine learning models such as those described herein may implement multiple machine learning algorithms with multiple different inputs. To illustrate an example, a machine learning model may use scene classification as a first input for a first machine learning algorithm and motion sensor information as a second input for a second machine learning algorithm.

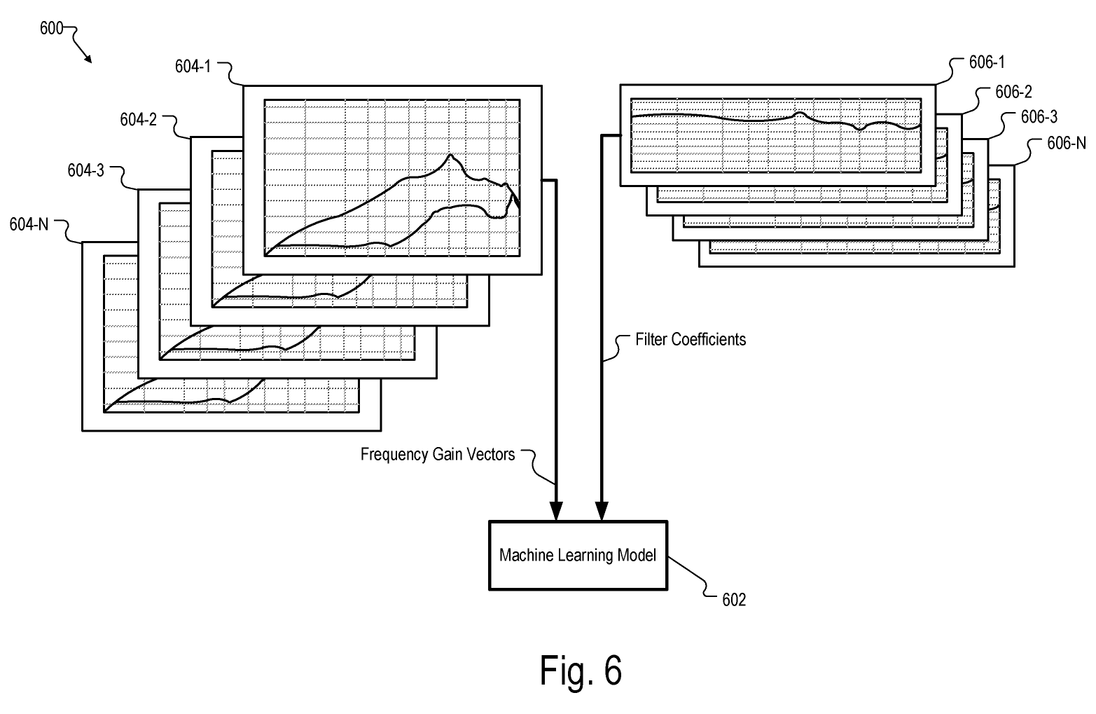

The training data may correspond to any suitable training data that may be used in a given implementation. In instances where a sound processing program corresponds to a gain model algorithm that implements an adaptive filter, a machine learning model may be trained based on target gain curves low-latency filter pairs. To illustrate, FIG. 6 shows an exemplary diagram 600 that depicts information that may be used to train a machine learning model in certain examples. As shown in FIG. 6, a machine learning model 602 may be trained based on a plurality of target gain curves 604 (e.g., target gain curves 604-1 through 604-N) and a plurality of low-latency filters 606 (e.g., low-latency filters 606-1 through 606-N). In the example shown in FIG. 6, low-latency filter 606-1 may include filter coefficients that are low-latency and are stable for target gain curve 604-1. Similarly, low-latency filter 606-2 may include low-latency and stable filter coefficients for target gain curve 604-2, and so forth. The data used to train machine learning model 602 may be acquired from any suitable source. For example, target gain curves 604 and/or low-latency filters 606 may be acquired from a hearing device fitting facility, one or more other hearing devices associated with other users, a hearing device manufacturer, and/or any other suitable source.

Target gain curves 604 and low-latency filters 606 may be processed in any suitable manner to facilitate training machine learning model 602. For example, a plurality of frequency gain vectors may be derived from target gain curves 604. In addition, a plurality of filter coefficients may be derived from low-latency filters 606.

During training, the training data (e.g., frequency gain vectors and/or the filter coefficients) may be passed through the machine learning model to generate predictions. The machine learning model’s predictions may be compared to actual target values using the loss function. Gradients of the loss function may be computed with respect to each model parameter and backpropagated through the network. The machine learning model may use the gradients computed during backpropagation to update the parameters of the machine learning model. These operations may be repeated any suitable number of times for multiple iterations or epochs. Each iteration or epoch may involve feeding the training data through the machine learning model, calculating the loss, performing backpropagation to compute gradients, and updating parameters accordingly to train the machine learning model.

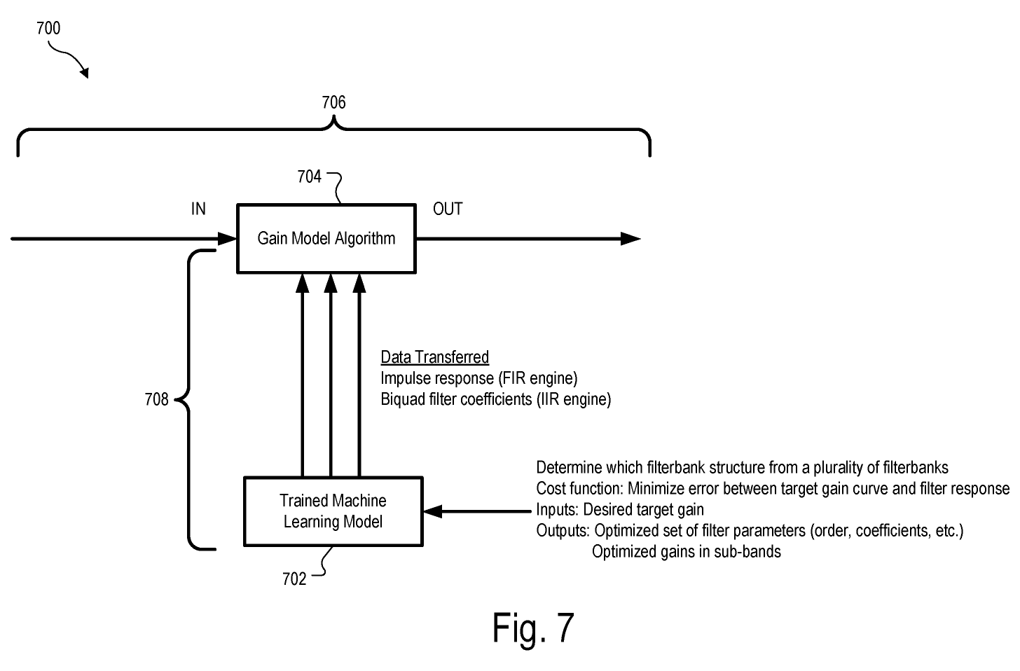

FIG. 7 shows an additional exemplary diagram 700 depicting signal processing paths that may be implemented in examples where a sound processing program corresponds to a gain model algorithm. As shown in FIG. 7 a trained machine learning model 702 may be trained to determine which filterbank structure to use from a plurality of filterbank structures for a given situation. The cost function of trained machine learning model 702 may be to minimize error between a target gain curve and a filter response. As shown in FIG. 7, inputs to trained machine learning model 702 may include a desired target gain. The outputs for trained machine learning model 702 may include an optimized set of filter parameters (e.g., optimized filter order, optimized filter coefficients, etc.). In the example shown in FIG. 7, the data transferred from trained machine learning model 702 to a gain model algorithm 704 may include impulse response and/or biquad filter coefficients.

As shown in FIG. 7, gain model algorithm may process an audio signal along a first signal processing path 706 and trained machine learning model 702 may process the audio signal along a second signal processing path 708. In certain examples, first signal processing path 708 may have a different latency than second signal processing path 708. For example, first signal processing path 706 may have a latency of ten milliseconds or less and second signal processing path 708 may have a latency of one second or less.

In certain examples, system 100 may be configured to optimize one or more parameters for a beamformer program. The beamformer program may correspond to any suitable type of beamformer program. For example, a monaural and/or a binaural beamformer may be used in certain implementations. The performance of a monaural and/or a binaural beamformer depends on the fit on the ear and individual head anatomy. The beamformer performance may go down due to individual anatomical variances and/or if a hearing device is worn differently than manufacture specifications and/or microphone attrition. Accordingly, system 100 may be configured to implement a trained machine learning model dynamically optimize one or more parameters of a beamformer program to account for anatomical differences and/or different wearing positions and/or different microphone attrition of a hearing device.

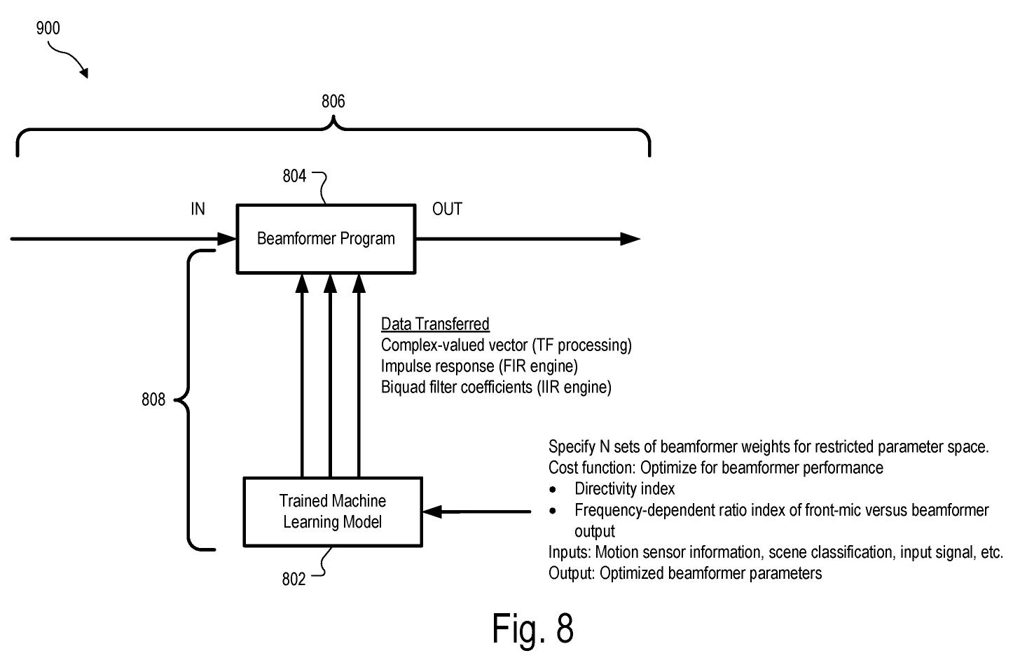

FIG. 8 shows an exemplary diagram 800 depicting signal processing paths that may be implemented in examples where a sound processing program corresponds to a beamformer program. As shown in FIG. 8 a trained machine learning model 802 may be trained to specify N sets of beamformer weights for a restricted parameter space. The cost function of trained machine learning model 802 may be to optimize for beamformer performance based on a directivity index and/or a frequency-dependent ratio index of front-mic versus beamformer output. As shown in FIG. 8, inputs to trained machine learning model 802 may include motion sensor information (used to infer the orientation of a hearing device on the head of a user), the input audio signal, scene classification information, and/or any other suitable information. The outputs for trained machine learning model 802 may include the optimal beamformer parameters based on the motion sensor information and/or any suitable other information. In the example shown in FIG. 8, the data transferred from trained machine learning model 802 to a beamformer program 804 may include complex-valued vectors, impulse response data (e.g., associated with an FIR engine, and/or biquad filter coefficients (e.g., associated with an IIR engine).

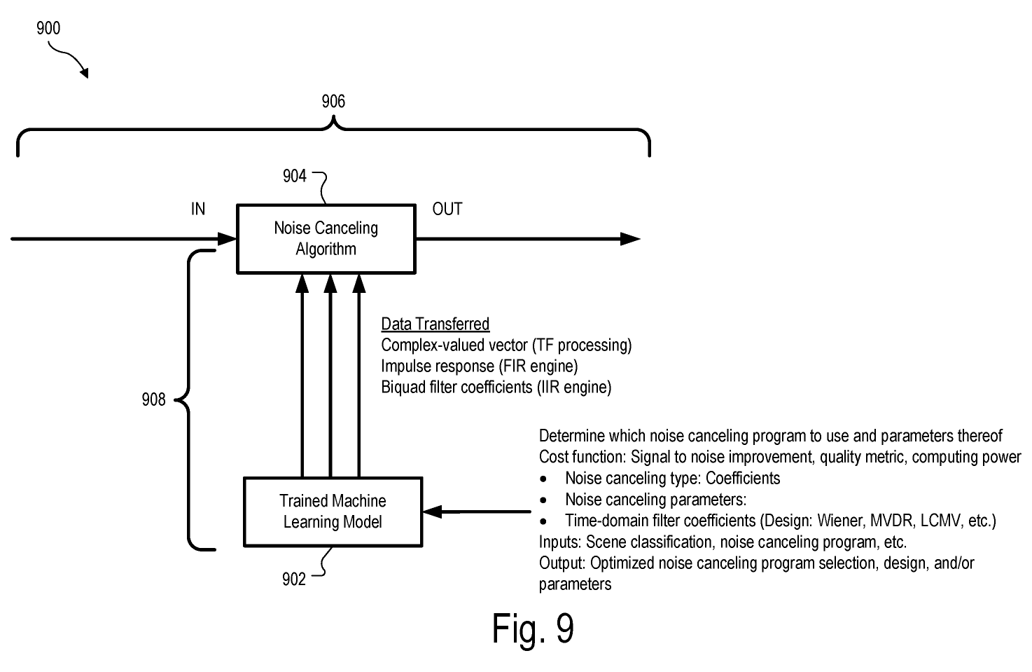

As shown in FIG. 8, beamformer program 804 may process an audio signal along a first signal processing path 806 and trained machine learning model 802 may process the audio signal along a second signal processing path 808. In certain examples, first signal processing path 806 may have a different latency than second signal processing path 808. For example, first signal processing path 806 may have a latency of ten milliseconds or less and second signal processing path 808 may have a latency of one second or less. FIG. 9 shows an exemplary diagram 900 depicting signal processing paths that may be implemented in examples where a sound processing program corresponds to a noise canceling algorithm. As shown in FIG. 9 a trained machine learning model 902 may be trained to determine which noise canceling program to use for a given situation and the parameters of the noise canceling algorithm. The cost function of trained machine learning model 902 may be to improve signal to noise, a quality metric, and/or computing power. Factors that may be considered in evaluating the cost function may include, for example, noise cancelling type (e.g., a single channel noise canceler, a DNN-based noise reduction program, etc.), noise cancelling parameters (e.g., parameters used for a directional noise cancelling algorithm), time-domain filter coefficients, etc. The loco parameters may include any information about direction of arrival (“DOA”) of a sound (e.g., from a microphone array). The design of the noise canceling program may also be considered. Different noise canceling programs may include or otherwise implement a Wiener filter, a minimum variance distortionless response (“MVDR”) filter, a linearly constrained minimum variance (“LCMV”) filter, etc. As shown in FIG. 9, inputs to trained machine learning model 902 may include a scene classification, a noise canceling program, and/or any other suitable input. The outputs for trained machine learning model 902 may include a selection of an optimized noise canceling program, an optimized design of a noise canceling program, and/or optimized parameters of the noise canceling program. In the example shown in FIG. 9, the data transferred from trained machine learning model 902 to a gain model algorithm 904 may include a complex-valued vector, an impulse response, and/or biquad filter coefficients.

As shown in FIG. 9, noise canceling algorithm 904 may process an audio signal along a first signal processing path 906 and trained machine learning model 902 may process the audio signal along a second signal processing path 908. In certain examples, first signal processing path 906 may have a different latency than second signal processing path 908. For example, first signal processing path 906 may have a latency of ten milliseconds or less and second signal processing path 908 may have a latency of one second or less.

The examples shown in FIGS. 8 and 9 indicate that the data transferred may include complex-valued vector (TF processing), which may infer that the processing performed along signal processing paths 808 and 908 includes “time frequency processing” or frequency domain processing. However, it is understood that beamformer programs and/or noise cancelling algorithms may additionally or alternatively process an audio signal in a time domain (e.g., without requiring complex-valued vector (TF processing) in certain examples.

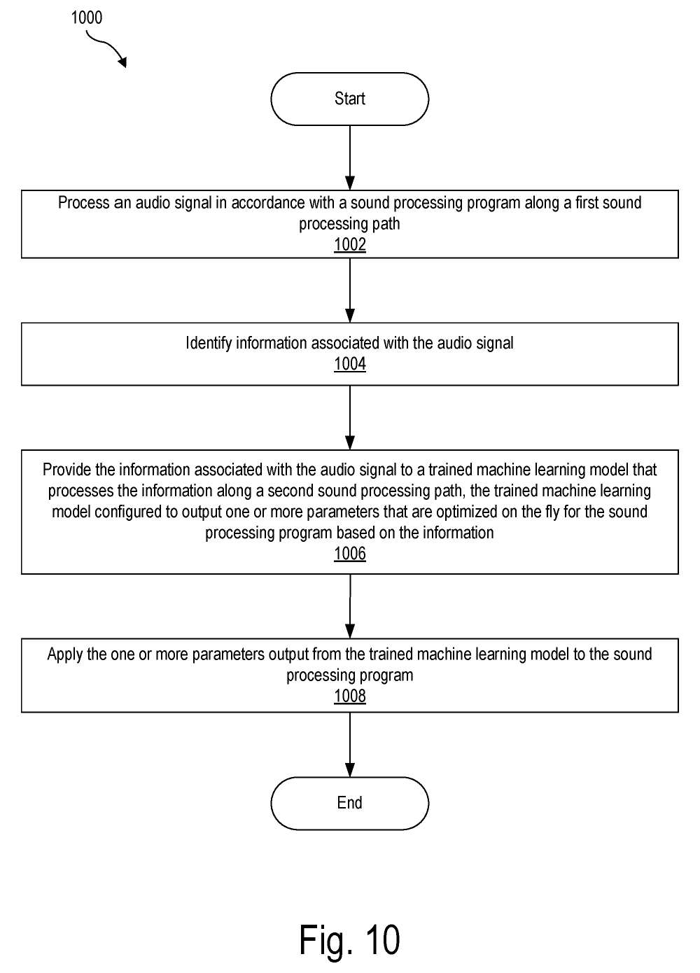

FIG. 10 illustrates an exemplary method 1000 for implementing a machine learning model to optimize sound processing program parameters according to principles described herein. While FIG. 10 illustrates exemplary operations according to one embodiment, other embodiments may omit, add to, reorder, and/or modify any of the operations shown in FIG. 10. One or more of the operations shown in FIG. 10 may be performed by hearing device designing system 100, an additional computing device communicatively coupled to system 100, any components included therein, and/or any combination or implementation thereof.

At operation 1002, an audio content processing system such as audio content processing system 100 may process an audio signal in accordance with a sound processing program along a first signal processing path that has a first latency. As described herein, the sound processing program may be configured to compensate for individual hearing loss of a user of a hearing device. Operation 1002 may be performed in any of the ways described herein.

At operation 1004, the system may identify information associated with the audio signal. Operation 1004 may be performed in any of the ways described herein.

At operation 1006, the system may provide the information associated with the audio signal to a trained machine learning model that processes the information along a second signal processing path that has a second latency different than the first latency. The trained machine learning model may be configured to output one or more parameters that are optimized on the fly for the sound processing program based on the information. Operation 1006 may be performed in any of the ways described herein.

At operation 1008, the system may apply the one or more parameters output from the trained machine learning model to the sound processing program. Operation 1008 may be performed in any of the ways described herein.

In some examples, a computer program product embodied in a non-transitory computer-readable storage medium may be provided. In such examples, the non-transitory computer-readable storage medium may store computer-readable instructions in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

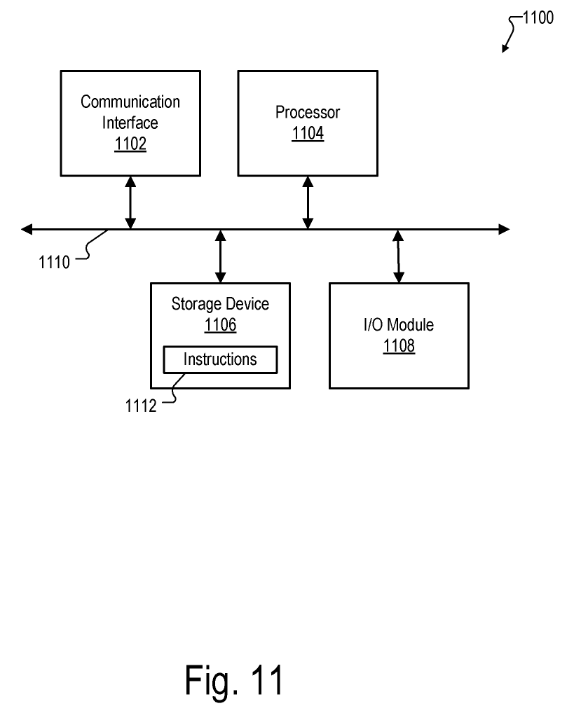

FIG. 11 illustrates an exemplary computing device 1100 that may be specifically configured to perform one or more of the processes described herein. As shown in FIG. 11, computing device 1100 may include a communication interface 1102, a processor 1104, a storage device 1106, and an input/output (“I/O”) module 1108 communicatively connected one to another via a communication infrastructure 1110. While an exemplary computing device 1100 is shown in FIG. 11, the components illustrated in FIG. 11 are not intended to be limiting. Additional or alternative components may be used in other embodiments. Components of computing device 1100 shown in FIG. 11 will now be described in additional detail.

Communication interface 1102 may be configured to communicate with one or more computing devices. Examples of communication interface 1102 include, without limitation, a wired network interface (such as a network interface card), a wireless network interface (such as a wireless network interface card), a modem, an audio/video connection, and any other suitable interface.

Processor 1104 generally represents any type or form of processing unit capable of processing data and/or interpreting, executing, and/or directing execution of one or more of the instructions, processes, and/or operations described herein. Processor 1104 may perform operations by executing computer-executable instructions 1112 (e.g., an application, software, code, and/or other executable data instance) stored in storage device 1106.

Storage device 1106 may include one or more data storage media, devices, or configurations and may employ any type, form, and combination of data storage media and/or device. For example, storage device 1106 may include, but is not limited to, any combination of the non-volatile media and/or volatile media described herein. Electronic data, including data described herein, may be temporarily and/or permanently stored in storage device 1106. For example, data representative of computer-executable instructions 1112 configured to direct processor 1104 to perform any of the operations described herein may be stored within storage device 1106. In some examples, data may be arranged in one or more databases residing within storage device 1106.

I/O module 1108 may include one or more I/O modules configured to receive user input and provide user output. I/O module 1108 may include any hardware, firmware, software, or combination thereof supportive of input and output capabilities. For example, I/O module 1108 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1108 is configured to provide graphical data to a display for presentation to a user. The graphical data may be representative of one or more graphical user interfaces and/or any other graphical content as may serve a particular implementation.

In some examples, any of the systems, hearing devices, computing devices, and/or other components described herein may be implemented by computing device 1100. For example, memory 102 and/or memory 206 may be implemented by storage device 1106, and processor 104 and/or processor 208 may be implemented by processor 1104.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A hearing device comprising:
a memory storing instructions; and
a processor communicatively coupled to the memory and configured to execute the instructions to perform a process comprising:
processing an audio signal in accordance with a sound processing program along a first signal processing path, the sound processing program configured to compensate for individual hearing loss of a user of the hearing device;
identifying information associated with the audio signal;
providing the information associated with the audio signal to a trained machine learning model that processes the information along a second signal processing path, the trained machine learning model configured to output one or more parameters that are optimized on the fly for the sound processing program based on the information; and
applying the one or more parameters output from the trained machine learning model to the sound processing program.

2. The hearing device of claim 1, wherein the processing of the audio signal along the first signal processing path is performed in the time domain.

3. The hearing device of claim 1, wherein the processing of the audio signal along the first signal processing path is performed in the frequency domain.

4. The hearing device of claim 1, wherein:
the sound processing program comprises a gain model algorithm that implements an adaptive filter; and
the one or more parameters optimized by the machine learning model include at least one of a filter bank structure, a filter order, or filter coefficients for the adaptive filter.

5. The hearing device of claim 4, wherein the adaptive filter is an infinite impulse response (IIR) filter.

6. The hearing device of claim 4, wherein the trained machine learning model is further configured to output the one or more parameters based on an input target gain curve.

7. The hearing device of claim 4, wherein:
the one or more parameters include the filter coefficients for the adaptive filter; and
the trained machine learning model is trained to determine the filter coefficients using a gain curve to coefficients mapping function.

8. The hearing device of claim 1, wherein:
the sound processing program comprises a beamformer algorithm; and
the one or more parameters optimized by the machine learning model include beamformer weights used by the beamformer algorithm.

9. The hearing device of claim 8, wherein the information includes motion sensor data.

10. The hearing device of claim 1, wherein:
the sound processing program comprises a noise canceling algorithm that is configured to implement a plurality of different noise canceling programs; and
the one or more parameters optimized by the machine learning model include a noise canceling program selected from a plurality of different noise canceling programs.

11. The hearing device of claim 1, wherein the information is derived from the audio signal.

12. The hearing device of claim 1, wherein the information is derived from a source other than the audio signal.

13. The hearing device of claim 1, wherein the identifying of the information comprises determining an input sound classification associated with sound in an environment in which the hearing device is located.

14. The hearing device of claim 1, wherein the process further comprises:
identifying, after the applying of the one or more parameters to the sound processing program, additional information associated with the audio signal;
providing the additional information to the trained machine learning model that is configured to output one or more additional parameters that are optimized on the fly for the sound processing program based on the additional information; and
applying the one or more additional parameters output from the trained machine learning model to the sound processing program in place of the one or more parameters.

15. The hearing device of claim 1, wherein:
the first signal processing path has a first latency; and
the second signal processing path has a second latency that is different than the first latency.

16. The hearing device of claim 15, wherein the first latency is less than the second latency.

17. A computer program product embodied in a non-transitory computer readable storage medium and comprising computer instructions for:
processing an audio signal in accordance with a sound processing program along a first signal processing path that has a first latency, the sound processing program configured to compensate for individual hearing loss of a user of a hearing device;
identifying information associated with the audio signal;
providing the information associated with the audio signal to a trained machine learning model that processes the information along a second signal processing path that has a second latency different than the first latency, the trained machine learning model configured to output one or more parameters that are optimized on the fly for the sound processing program based on the information; and
applying the one or more parameters output from the trained machine learning model to the sound processing program.

18. The computer program product of claim 17, wherein the process further comprises:
identifying, after the applying of the one or more parameters to the sound processing program, additional information associated with the audio signal;
providing the additional information to the trained machine learning model that is configured to output one or more additional parameters that are optimized on the fly for the sound processing program based on the additional information; and
applying the one or more additional parameters output from the trained machine learning model to the sound processing program in place of the one or more parameters.

19. The computer program product of claim 17, wherein:
the sound processing program comprises a gain model algorithm that implements an adaptive filter; and
the one or more parameters optimized by the machine learning model include at least one of a filter bank structure, a filter order, or filter coefficients for the adaptive filter.

20. A method comprising:
processing, by an audio content processing system, an audio signal in accordance with a sound processing program along a first signal processing path that has a first latency, the sound processing program configured to compensate for individual hearing loss of a user of a hearing device;
identifying, by the audio content processing system, information associated with the audio signal;
providing, by the audio content processing system, the information associated with the audio signal to a trained machine learning model that processes the information along a second signal processing path that has a second latency different than the first latency, the trained machine learning model configured to output one or more parameters that are optimized on the fly for the sound processing program based on the information; and
applying, by the audio content processing system, the one or more parameters output from the trained machine learning model to the sound processing program.
